(19) United States
(12) Patent Application Publication
(10) Pub. No.: US 2020/0109597 A1
(43) Pub. Date: Apr. 9, 2020

(54) anti-theft window convenient for middle and high-level emergency escape

(71) Applicant: Xiaoling Tu, Shanghai City (CN)

(72) Inventor: Xiaoling Tu, Shanghai City (CN)

(21) Appl. No.: 16/708,382

(22) Filed: Dec. 9, 2019

(30) Foreign Application Priority Data
Aug. 27, 2019 (CN) 2019107984860

(51) Int. Cl. E06B 5/00; E06B 3/38; E06B 3/32; E06B 7/28; E06B 9/01; E05C 3/00; E05C 3/12

(52) U.S. Cl. CPC E06B 5/00; E06B 3/38; E06B 3/325; E05C 3/124; E06B 9/01; E05C 3/006; E06B 7/28

(57) ABSTRACT

The invention discloses an anti-theft window which is convenient for emergency escape of middle and high-rises, and includes a wall. The wall is provided with a housing space. There is a lower window sill, the rear end surface of the lower window sill is fixed on the wall body, the upper end surface of the window is fixed with a left-right symmetrical retaining wall, and an anti-theft window is provided between the retaining walls. The device and the locking device can detachably and stably install the window frame on the front side of the window, which can ensure the safety of the personnel inside the room. Secondly, in the event of an emergency, the window frame is detachable to facilitate outdoor personnel to enter the room for rescue, and the window frame It can be used as a flat board, and people in the room can ride on the window frame and land on the ground through fire protection ropes to escape.

### CROSS-REFERENCES TO RELATED APPLICATIONS

The present application claims priority from Chinese application No. 2019107984860 filed on Aug. 27, 2019 which is hereby incorporated by reference in its entirety.

### FIELD OF TECHNOLOGY

The invention relates to the technical field of escape equipment, and in particular relates to an anti-theft window convenient for middle and high-level emergency escape.

### Technical Field

Traditional anti-theft windows install anti-theft nets on windows to prevent illegal persons outside the windows from entering the room, and the anti-theft windows only serve as anti-theft functions with a single function. Second, the anti-theft windows and windows are fixedly installed, and fires or emergency escape accidents occur in the middle and high-rise indoors. At this time, the anti-theft window will hinder the emergency escape of the indoor personnel, and prevent the indoor personnel from entering the room for rescue work, resulting in its small scope of application and inconvenience.

Secondly, it is difficult to escape from indoors in the event of an emergency (such as a fire) in middle and high-rises, and it is difficult to escape if the room is located on a high-rise. In addition, some mid-to-high-rise windows are equipped with escape ladders and other devices. This device is highly restricted and escapes. Ladder is only suitable for people with good physique who can climb by themselves, it is not convenient for promotion. The present invention illustrates a device capable of solving the above problems.

### Content of the Invention

Technical problem: the traditional anti-theft window has a single function, is inconvenient for emergency escape, and has limited use.

In order to solve the above problem, this example designs an anti-theft window that facilitates emergency escape of middle and high-rises, and an anti-theft window that facilitates emergency escape of middle and high-rises in this example includes a wall, and a housing space is provided in the wall. A window is provided between the front side of the house space and the outside. The front side of the window is provided with a lower window sill. The rear end surface of the lower window sill is fixed on the wall. Retaining wall, an anti-theft window is provided between the retaining walls, a plug-in device is provided in the retaining wall, and the plug-in device can stably connect the anti-theft window and the retaining wall, and the anti-theft window includes An anti-theft net. Four anti-theft devices are arranged in the anti-theft net. An upper window edge is fixed between the end faces of the retaining wall, and the rear edge of the upper window edge is fixed on the wall body. The upper window edge is provided inside. There is a locking device, which can be locked and connected with the security window, so as to serve as a barrier of the window to protect the safety of the house space, a rope device is provided on the upper side of the locking device, and the rope device Including four ropes, the rope and the security window Even, to the device side of the rope is provided with telescopic runners, the runners may be telescopic drive the rope horizontal scaling means connected between said power transmitting means via cable means and said telescopic runners.

Preferably, the anti-theft net is made of a high-strength and fire-proof material, so that the anti-theft net can be used to prevent illegal destruction by people inside and outside the house space, and the anti-theft net can withstand three when placed horizontally.

### Middle-Aged Man Weight.

Preferably, the rope is made of a fire-resistant material, so that the rope will not be broken under the influence of high temperature when used in a fire.

Wherein, the anti-theft window package window frame, the upper and lower corners of the window frame are fixedly connected with the rope, the window frame is provided with a ventilation cavity, the anti-theft net is fixedly installed in the ventilation cavity, and the window frame The left and right ends are fixedly provided with a rotation shaft, and an end away from the window frame is provided with a mounting block. The mounting block has a plug-in slot therein, and the plug-in slot is connected to the plug-in device. A fixed lock block is fixed on the rear end surface of the window frame, and the fixed lock block is connected to the locking device, so that the window frame can be stably installed in the retaining wall.

Wherein, the plug-in device includes a left-right symmetrical groove, the mounting block is located in the groove, an upper pull groove is communicated with the upper side of the groove, and the pull groove is located in the retaining wall. A pull-up block is slidably arranged in the pull-up slot, the lower end of the pull-up block projects into the insertion slot, and a return spring is fixed on the upper end surface of the pull-up block, so that the pull-up block and the The plugging slot can be connected to make the window frame and the retaining wall stably connected.

Wherein, the protection device includes a protection block, which is fixed between the window frame and the anti-theft net. The protection block is provided with a sliding cavity. The sliding cavity is provided with a sliding block. A pressure spring is fixed between an end surface of the sliding block far from the retaining wall and the mounting block. A protective chute is provided in the sliding block, and a protective shaft is rotatably provided in the protective chute. A protective plate is fixed on the protective rotating shaft. A supporting plate is fixed on an end of the protective plate far from the pressure spring. A slot is formed between the sliding cavity and the ventilation cavity, and the upper and lower sides of the slot communicate with each other. A card slot is provided, and a card block is slidably arranged in the card slot. An end of the card block away from the protection plate is fixed with a compression spring, and a front end surface of the card block is fixed with a shift lever, so that When the protective plate is rotated to be perpendicular to the window frame, the clamping block abuts the protective plate, thereby locking the position of the protective plate.

Wherein, the locking device comprises an opening cavity, a locking cavity is provided at the rear side of the opening cavity, a fixed shaft is fixed in the locking cavity, a rotating gear is rotatably arranged on the fixed shaft, and a movable lock block is fixed at the front end of the rotating gear The movable lock block is overlapped with the fixed lock block, a torsion spring is fixed between the lower end surface of the movable lock block and the lock cavity, and a communication device is provided between the rear side of the lock cavity and the housing space. There is a pressing groove. A pressing rod is slidably arranged in the pressing groove. The lower end surface of the pressing rod meshes with the rotating gear. The rear end of the pressing rod extends into the housing space. The upper end surface of the pressing rod is fixed. There is a guide slider, and a pressing spring is fixed on the front surface of the guide slider, so that the fixed lock block overlaps with the movable lock block so that the window frame and the upper window edge can be locked and connected by pushing forward The pressing lever can disengage the fixed lock block from the movable lock block. Wherein, the rope device includes a moving cavity, and a moving block is slidably provided in the moving cavity. A tensioning cavity is provided in the moving block. A tensioning shaft is provided in the tensioning cavity and the tensioning shaft is rotated. A tensioning wheel is fixed on the upper side, a winding chamber is communicated with the back side of the moving cavity, and a winding shaft is rotated in the winding chamber. The left end of the winding shaft is dynamically connected with the transmission device, and the winding shaft A winding wheel is fixed on the upper side, the upper end of the rope passes around the tensioning wheel, extends into the winding chamber and is fixedly wound on the winding wheel, and the right end wall of the winding chamber is fixedly provided. A power motor, the right end of the rewinding shaft is dynamically connected to the power motor, so that the power motor works to drive the rewinding wheel to rotate and retract the rope, so as to control the placement state of the window frame.

Wherein, the telescopic sliding guide device includes a telescopic chute, and a touch module is installed at the front wall of the telescopic chute. A rotary screw is rotatably provided in the telescopic chute, and the telescopic slide is screwed to the rotary screw. Block, the telescopic slider is fixedly connected to the moving block, a meshing cavity is provided on the rear side of the telescopic chute, and the rear end of the rotating screw extends into the meshing cavity and a first bevel gear is fixedly arranged A second bevel gear is meshedly connected to the left end of the first bevel gear, and a gear rotating shaft is fixed at the shaft center of the second bevel gear; the gear rotating shaft is dynamically connected with the transmission device, so that the rotating screw rotates The telescopic slider can be caused to move the moving block.

Wherein, the transmission device includes a transmission cavity, a transmission block is slidably arranged in the transmission cavity, the gear shaft is rotatably connected to the transmission block, a hydraulic cylinder is fixed on the left end wall of the transmission cavity, and the touch module The hydraulic cylinder can be controlled to work. A telescopic shaft is installed on the hydraulic cylinder, the telescopic shaft is fixedly connected to the transmission block, a belt cavity is provided on the left side of the transmission cavity, and a rotation is provided in the belt cavity. The upper and lower symmetrical pulleys are connected by a driving belt. The left end of the winding shaft is fixedly connected with the pulley on the lower side. The upper side of the pulley is provided with a spline groove. The spline groove is splined, so that when the gear shaft is connected to the spline groove, the power motor works to drive the rope device to work with the telescopic slide device, otherwise, the power motor only drives the The rope device works.

The beneficial effect of the present invention is that the present invention detachably and stably installs the window frame on the front side of the window through the plug-in device and the locking device, which can ensure the safety of the personnel inside the room. Secondly, the window frame can be detached in the event of an emergency It is convenient for outdoor personnel to enter the room for rescue, and the window frame can be used as a flat panel. Indoor personnel can ride on the window frame and descend to the ground through fire protection ropes to escape. Among them, the window frame is equipped with protective devices, and the protective panel can guarantee The landing process is balanced and safe, and is suitable for the escape of persons of different physiques.

### BRIEF DESCRIPTION OF THE DRAWINGS

For ease of description, the present invention is described in detail by the following specific embodiments and the accompanying drawings.

FIG. 1 is a schematic diagram of the overall structure of an anti-theft window that facilitates emergency escape of middle and high-rises;

FIG. 2 is a schematic structural diagram of the direction “A-A” of FIG. 1;

FIG. 3 is an enlarged structural diagram of “B” in FIG. 1;

FIG. 4 is a schematic structural diagram of a direction “C-C” of FIG. 3;

FIG. 5 is an enlarged structural diagram of “D” of FIG. 2;

FIG. 6 is a schematic structural diagram of the “E-E” direction of FIG. 5;

FIG. 7 is a schematic diagram of the “used state” structure of FIG. 2.

### DETAILED DESCRIPTION OF THE INVENTION

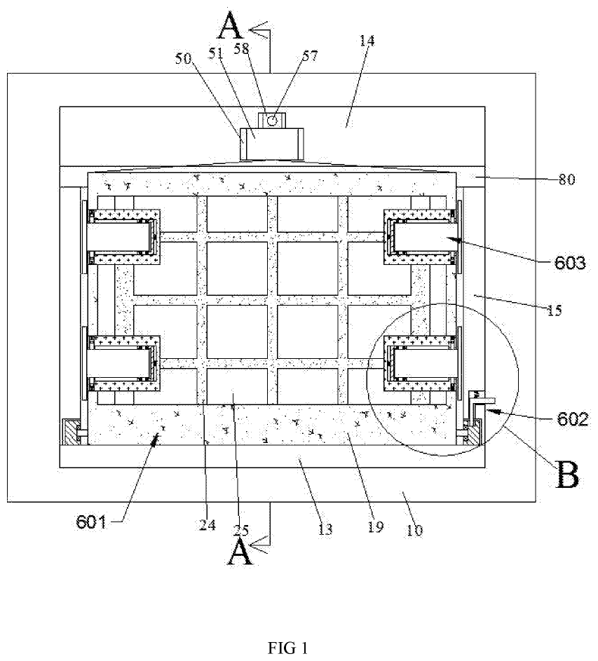

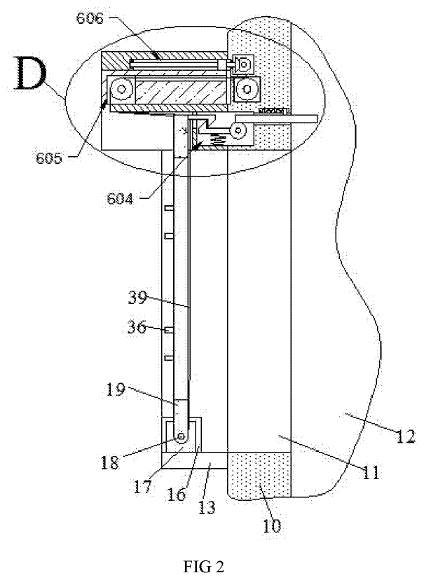

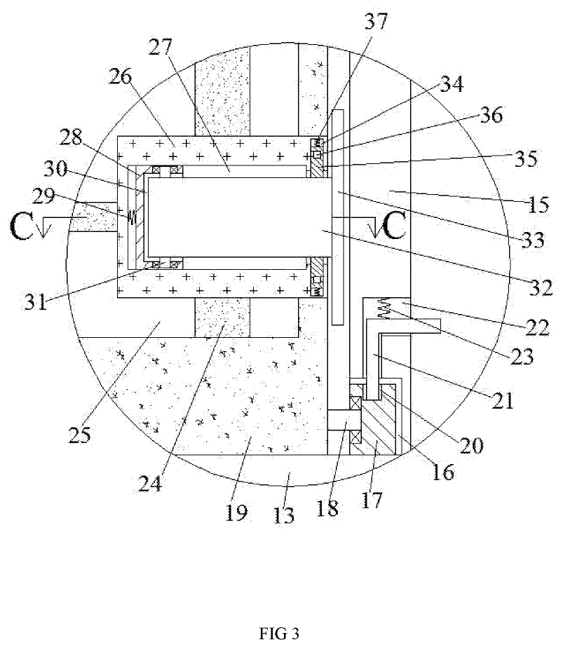

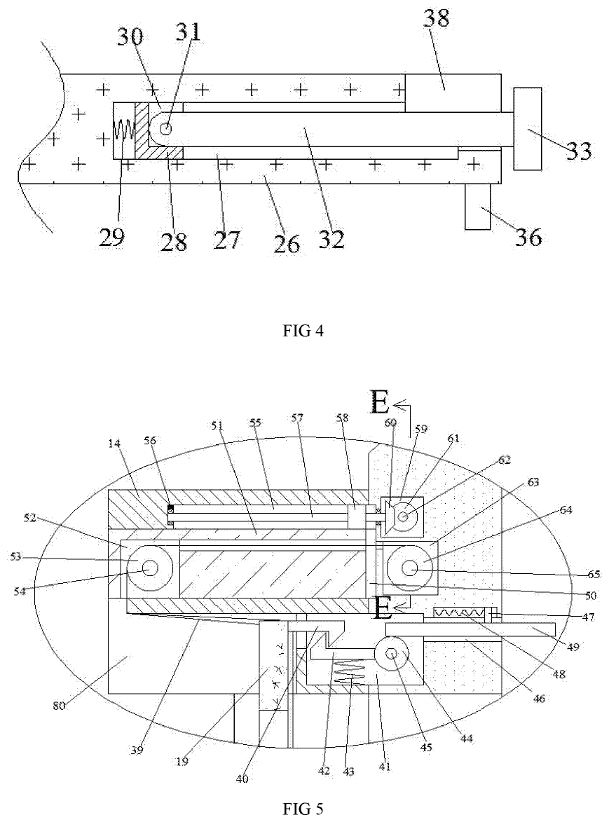

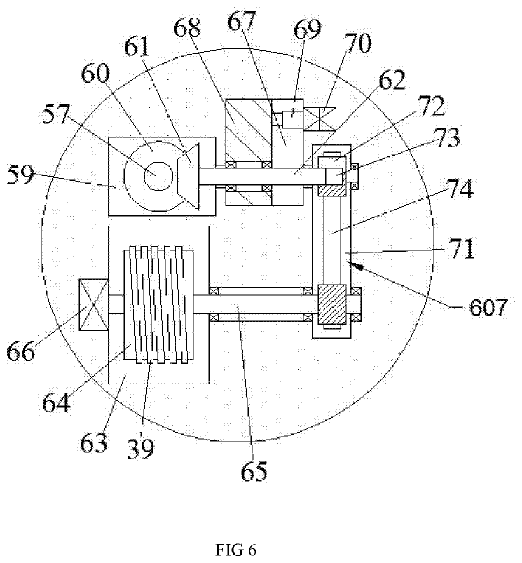

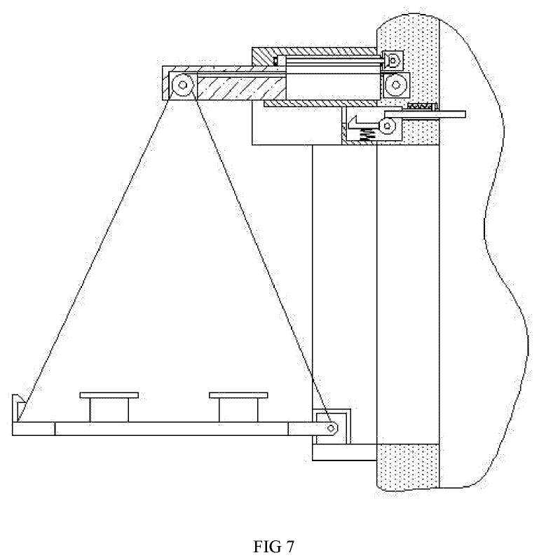

The present invention is described in detail below with reference to FIGS. 1 to 7.

For convenience of description, the orientation described below is defined as follows: the up-down, left-right, front-back direction described below is consistent with the up-down, left-right, front-back direction of the projection relationship of FIG. 1 itself. The present invention relates to an anti-theft window which is convenient for emergency escape of middle and high-rises, and is mainly used for emergency escape work. The present invention will be further described below with reference to the accompanying drawings of the present invention:

An anti-theft window convenient for middle and high-level emergency escape according to the present invention includes a wall 10, and a wall 12 is provided in the wall 10, and a window 11 is provided between the front side of the room space 12 and the outside. A lower window sill 13 is provided on the front side of the window 11, a rear end surface of the lower window sill 13 is fixed on the wall 10, and a left-right symmetrical retaining wall 15 is fixed on the upper end of the window 11. An anti-theft window 601 is provided between 15 and a plug-in device 602 is provided in the retaining wall 15. The plug-in device 602 can stably connect the anti-theft window 601 and the retaining wall 15 within the anti-theft window 601. It includes an anti-theft net 24. Four anti-theft devices 603 are provided in the anti-theft net 24. An upper window edge 14 is fixed between the upper end surfaces of the retaining wall 15 and a rear end of the upper window edge 14 is fixed to the wall body 10. Above, the upper window edge 14 is provided with a locking device 604, and the locking device 604 can be locked and connected with the anti-theft window 601, so as to serve as a barrier of the window 11 to protect the safety of the house space 12, so A rope device 605 is provided on the upper side of the locking device 604. The rope device 605 includes four ropes 39. The rope 39 and the rope 39 A robbery window 601 is fixedly connected, and a telescopic guide device 606 is provided on the upper side of the rope device 605. The telescopic guide device 606 can drive the rope device 605 to expand and contract horizontally. 606 is power-connected through a transmission 607.

Beneficially, the anti-theft net 24 is made of a high-strength and fire-proof material, so that the anti-theft net 24 can be used to prevent people inside and outside the house space 12 from being illegally destroyed, and the anti-theft net 24 can Withstands the weight of three middle-aged men.

Beneficially, the rope 39 is made of a fire-resistant material, so that the rope 39 will not be broken by the influence of high temperature when used in a fire.

According to the embodiment, the security window 601 is described in detail below. The security window 601 includes a window frame 19, the upper and lower four corners of the window frame 19 are fixedly connected to the rope 39, and the window frame 19 is provided with a ventilation cavity 25. The anti-theft net 24 is fixed in the ventilation cavity 25. The left and right ends of the window frame 19 are fixed with a rotating shaft 18, and the end of the rotating shaft 18 away from the window frame 19 is provided with a mounting block 17. The mounting block 17 has a plug-in slot 20 therein. The plug-in slot 20 is plug-in connected to the plug-in device 602. A rear end surface of the window frame 19 is fixed with a fixed locking block 40. The fixed locking block 40 and The locking device 604 is connected, so that the window frame 19 can be stably installed in the retaining wall 15.

According to the embodiment, the plug-in device 602 is described in detail below. The plug-in device 602 includes a left-right symmetrical groove 16, the mounting block 17 is located in the groove 16, and the upper side of the groove 16 is communicated with each other. There is a pull-up slot 22, which is located in the retaining wall 15. A pull-up block 21 is slidably arranged in the pull-up slot 22. The lower end of the pull-up block 21 projects into the plug-in slot 20. Inside, a return spring 23 is fixed on the upper end surface of the pull-up block 21 so that the pull-up block 21 is inserted into the insertion slot 20, so that the window frame 19 and the retaining wall 15 can be stably connected.

According to an embodiment, the protection device 603 is described in detail below. The protection device 603 includes a protection block 26 fixed between the window frame 19 and the anti-theft net 24. The protection block 26 A sliding cavity 27 is provided therein, and a sliding block 28 is slidably disposed in the sliding cavity 27. A pressure spring 29 is fixed between an end surface of the sliding block 28 away from the retaining wall 15 and the mounting block 17. The sliding block 28 is provided with a protective rotator 30 therein. The protective rotator 30 is rotatably provided with a protective rotating shaft 31. A protective plate 32 is fixed on the protective rotating shaft 31. A supporting plate 33 is fixed at one end, and a slot 38 is communicated between the sliding cavity 27 and the ventilation cavity 25. A slot 34 is formed on the upper and lower sides of the slot 38, and the slot 34 slides inside. A clamping block 35 is provided. An end of the clamping block 35 away from the protection plate 32 is fixed with a compression spring 37. A front end surface of the clamping block 35 is fixed with a lever 36, so that the protection plate 32 is rotated to When the window frame 19 is in a vertical state, the blocking block 35 abuts against the protection plate 32 to lock the position of the protection plate 32.

According to the embodiment, the locking device 604 will be described in detail below. The locking device 604 includes an opening cavity 80. A locking cavity 41 is provided on the rear side of the opening cavity 80. A fixed shaft 45 is fixed in the locking cavity 41. 45 is provided with a rotation gear 44. A movable lock block 42 is fixed at the front end of the rotation gear 44. The movable lock block 42 is overlapped with the fixed lock block 40. The lower end surface of the movable lock block 42 is locked with the lock. A torsion spring 43 is fixed between the cavities 41, and a pressing groove 46 is provided between the rear side of the locking cavity 41 and the housing space 12, and a pressing lever 49 is slidably arranged in the pressing groove 46. The pressing lever A lower end surface of the 49 meshes with the rotating gear 44, a rear end of the pressing rod 49 extends into the housing space 12, and a guide slider 47 is fixed on an upper end surface of the pressing rod 49. A pressing spring 48 is fixed, so that the fixed locking block 40 overlaps with the movable locking block 42 so that the window frame 19 and the upper window edge 14 are locked and connected. By pushing the pressing lever 49 forward. The fixed locking block 40 is disengaged from the movable locking block 42.

According to the embodiment, the rope device 605 is described in detail below. The rope device 605 includes a moving cavity 50, and a moving block 51 is slidably disposed in the moving cavity 50. A tensioning cavity 52 is provided in the moving block 51. A tensioning shaft 54 is rotatably provided in the tensioning cavity 52, a tensioning wheel 53 is fixed on the tensioning shaft 54, and a rewinding cavity 63 is connected to the rear side of the moving cavity 50. The rewinding cavity 63 An inner winding shaft 65 is provided. The left end of the winding shaft 65 is dynamically connected to the transmission device 607. The winding shaft 65 is fixedly provided with a winding wheel 64, and the upper end of the rope 39 passes around the tensioning wheel. After 53, it extends into the winding chamber 63 and is fixedly wound on the winding wheel 64. A power motor 66 is fixed on the right end wall of the winding chamber 63, and the right end of the winding shaft 65 is connected to the power. The motor 66, so that the power motor 66 works to drive the winding wheel 64 to rotate and retract the rope 39, so as to control the placement state of the window frame 19.

According to the embodiment, the telescopic sliding guide 606 is described in detail below. The telescopic sliding guide 606 includes a telescopic chute 55. A touch module 56 is installed at the front end wall of the telescopic chute 55. A rotation screw 57 is provided for rotation, and a telescopic slider 58 is screw-connected to the rotation screw 57. The telescopic slider 58 is fixedly connected to the moving block 51. The rear side of the telescopic slide groove 55 is provided with an engagement. Cavity 59, the rear end of the rotating screw 57 projects into the meshing cavity 59 and is fixed with a first bevel gear 60, and a left end of the first bevel gear 60 is meshed with a second bevel gear 61, and the second A gear rotating shaft 62 is fixed at the shaft center of the bevel gear 61, and the gear rotating shaft 62 is dynamically connected to the transmission device 607, so that the rotation of the rotating lead screw 57 can cause the telescopic slider 58 to drive the moving block 51 to move.

According to the embodiment, the transmission device 607 is described in detail below. The transmission device 607 includes a transmission cavity 67, and a transmission block 68 is slidably disposed in the transmission cavity 67. The gear rotating shaft 62 is rotatably connected to the transmission block 68. A hydraulic cylinder 70 is fixed on the left end wall of the transmission cavity 67, and the touch module 56 can control the operation of the hydraulic cylinder 70. A telescopic shaft 69 is installed on the hydraulic cylinder 70. The telescopic shaft 69 and the transmission The block 68 is fixedly connected. The left side of the transmission cavity 67 is provided with a belt cavity 71. Inside the belt cavity 71, an up-and-down symmetrical pulley 72 is provided. The pulleys 72 are dynamically connected by a transmission belt 74. The left end of the reel 65 is fixedly connected to the pulley 72 on the lower side, and a spline groove 73 is provided in the pulley 72 on the upper side. The left end of the gear rotating shaft 62 is splined to the spline groove 73, so that the gear rotating shaft 62 When connected to the spline groove 73, the power motor 66 works to drive the rope device 605 and the telescopic sliding device 606 to work together; otherwise, the power motor 66 only drives the rope device 605 to work.

The following describes in detail the use steps of an anti-theft window that is convenient for emergency escape of middle and high levels in this article with reference to FIGS. 1 to 7:

Initially, the window frame 19 is placed vertically, and the pull-up block 21 is inserted into the insertion slot 20, so that the lower end of the window frame 19 is stably installed with the retaining wall 15, and the fixed lock block 40 and the movable lock block 42 are overlapped, so that the window frame 19 The upper end is locked and connected to the upper window edge 14. At this time, the protective plate 32 is located in the sliding cavity 27, the clamping block 35 is in contact with the protective plate 32, the compression spring 37 is in a compressed state, and the gear rotating shaft 62 is splined to the spline groove 73.

For emergency escape use, the escape person is located in the housing space 12 and pushes the pressing lever 49 forward, so that the rotation gear 44 rotates, and then the movable lock block 42 rotates and disengages from the fixed lock block 40. At this time, the power motor 66 works so that When the take-up wheel 64 rotates, the window frame 19 is pulled forward to a horizontal state by the rope 39. At this time, the window 11 is in an open state. When the power motor 66 is working, the gear rotating shaft 62 can be driven by the transmission belt 74. The bevel gear 60 drives the rotating lead screw 57 to rotate, so that the telescopic slider 58 drives the moving block 51 to move forward to the front end of the tensioning wheel 53 and the center of the window frame 19. At this time, the telescopic slider 58 and The touch module 56 abuts, the hydraulic cylinder 70 works, and the transmission block 68 is pushed to the right through the telescopic shaft 69, and the gear rotating shaft 62 is disengaged from the spline groove 73, and at the same time, the power motor 66 stops working;

The person in the housing space 12 climbs to the window frame 19 through the window 11 and pulls the protective plate 32 to the outside. When the end of the sliding block 28 away from the symmetrical center abuts the inner end wall of the sliding cavity 27, the protective plate 32 is turned upward to In a state perpendicular to the window frame 19, the blocking block 35 slides against the rotation of the protective plate 32 under the elastic restoring force of the compression spring 37, thereby fixing the position of the protective plate 32, and the personnel on the window frame 19 can hold the supporting plate 33 keep balance;

Thereafter, the left and right pull-up blocks 21 are pulled upward to disengage them from the insertion slot 20, and then, the personnel support and the lower window sill 13 push the window frame 19 forward, so that the window frame 19 is separated from the groove 16 and the lower end of the window frame 19 Located at the front side of the lower window sill 13, at this time, the window frame 19 is connected to the lower window sill 13, the upper window edge 14 and the retaining wall 15 only through the rope 39, the power motor 66 works, and the winding wheel 64 rotates, and the rope 39 extends It is so long that the window frame 19 is lowered until the window frame 19 is brought to the ground with personnel.

The beneficial effect of the present invention is that the present invention detachably and stably installs the window frame on the front side of the window through the plug-in device and the locking device, which can ensure the safety of the personnel inside the room. Secondly, the window frame can be detached in the event of an emergency It is convenient for outdoor personnel to enter the room for rescue, and the window frame can be used as a flat panel. Indoor personnel can ride on the window frame and descend to the ground through fire protection ropes to escape. Among them, the window frame is equipped with protective devices, and the protective panel can guarantee The landing process is balanced and safe, and is suitable for the escape of persons of different physiques. In the above manner, those skilled in the art can make various changes according to the working mode within the scope of the present invention.

1. An anti-theft window that facilitates emergency escape of middle and high-rises, including a wall; a housing space is provided in the wall, a window is connected between the front side of the housing space and the outside, a lower window sill is provided on the front side of the window, and a rear end surface of the lower window sill is fixed on the wall; a left-right symmetrical retaining wall is fixed on the upper end surface of the window, and an anti-theft window is provided between the retaining walls. A plug-in device is provided in the wall, and the plug-in device can connect the anti-theft window with the The retaining wall is stably connected, the anti-theft window includes an anti-theft net, and the anti-theft net is provided with four protective devices; an upper window edge is fixed between the end faces of the retaining wall, and the rear end of the upper window edge is fixed on the wall body. A locking device is provided inside the upper window edge, and the locking device and the security window can be locked. Connected so as to be a partition of the window to protect the safety of the house space; a rope device is provided on the upper side of the locking device, the rope device includes four ropes, the rope is fixedly connected to the anti-theft window, and a telescopic slide device is provided on the upper side of the rope device, and the telescopic slide device The rope device can be driven to expand and contract horizontally, and the rope device and the telescopic sliding guide device are power-connected through a transmission device.

2. The anti-theft window for middle-to-high-level emergency escape according to claim 1, wherein the anti-theft net is made of a high-strength and fire-resistant material, and the anti-theft net can withstand three when placed horizontally. Middle-aged man weight.

3. The anti-theft window for facilitating emergency escape of middle and high-rise buildings according to claim 1, wherein the rope is made of fire-resistant material.

4. The anti-theft window for facilitating emergency escape of middle and high-rise buildings according to claim 1, wherein the anti-theft window covers a window frame; the upper and lower corners of the window frame are fixedly connected to the rope, a ventilation cavity is provided in the window frame, the anti-theft net is fixed in the ventilation cavity, and a rotation shaft is fixed to the left and right ends of the window frame; a mounting block is provided at an end of the rotating shaft far from the window frame, and a mounting slot is provided in the mounting block, the plugging slot is connected to the plugging device, and a rear end surface of the window frame is fixed. There is a fixed locking block which is connected to the locking device.

5. The anti-theft window for facilitating emergency escape of middle and high-rise buildings according to claim 1, wherein the plug-in device comprises a left-right symmetrical groove; the mounting block is located in the groove, and a pull-up groove is communicated with the upper side of the groove, and the pull-up groove is located in the retaining wall; a pull-up block is slidably arranged in the pull-up slot, a lower end of the pull-up block projects into the insertion slot, and a return spring is fixed on an upper end surface of the pull-up block.

6. The anti-theft window for facilitating emergency escape of middle and high-rise buildings according to claim 1, wherein the protective device comprises a protective block;
the protection block is fixed between the window frame and the anti-theft net. The protection block is provided with a sliding cavity. The sliding cavity is provided with a sliding block. The sliding block is far from the retaining wall. A pressure spring is fixed between one end surface and the mounting block; the sliding block is provided with a protective rotary groove, and a protective rotary shaft is rotatably arranged in the protective rotary groove. A protective plate is fixed on the protective rotary shaft, and a supporting plate is fixed on an end of the protective plate far from the pressure spring; a slot is communicated between the sliding cavity and the ventilation cavity, and a slot is communicated with the upper and lower sides of the slot. A slot is slidably disposed in the slot, and the slot is away from the protective plate. A compression spring is fixed at one end, and a shift lever is fixed at the front surface of the clamping block.

7. The anti-theft window for facilitating emergency escape of middle and high-rise buildings according to claim 1, wherein the locking device comprises an open cavity; the back side of the opening cavity is provided with a locking cavity, and a fixed shaft is fixed in the locking cavity; a rotating gear is rotatably provided on the fixed shaft; a movable lock block is fixed at the front end of the rotating gear, and the movable lock block and the fixed lock block is overlapped, and a torsion spring is fixed between the lower end surface of the movable lock block and the lock cavity; a pressing groove is communicated between the rear side of the lock cavity and the housing space, and a pressing rod is slidably arranged in the pressing groove. The lower end surface of the pressing rod meshes with the rotating gear, and the rear end of the pressing rod extends. In the housing space, a guide slider is fixed on the upper end surface of the pressing rod, and a pressing spring is fixed on the front end surface of the guide slider.

8. The anti-theft window for facilitating emergency escape of middle and high-rise buildings according to claim 1, wherein the rope device comprises a moving cavity; a moving block is slidably arranged in the moving cavity, a tensioning cavity is arranged in the moving block, a tensioning shaft is rotated in the tensioning cavity, and a tensioning wheel is fixed on the tensioning shaft; a winding chamber is connected to the rear side of the moving chamber, and a winding shaft is rotatably arranged in the winding chamber. The left end of the winding shaft is dynamically connected to the transmission device. A winding wheel is fixed on the winding shaft. The upper end of the rope passes around the tensioning wheel, extends into the winding chamber and is fixedly wound on the winding wheel. A power motor is fixed on the right end wall of the winding chamber, and the right end of the winding shaft The power is connected to the power motor.

9. The anti-theft window for facilitating emergency escape of middle and high-rise buildings according to claim 1, wherein the telescopic sliding guide device comprises a telescopic chute; a touch module is installed at the front wall of the telescopic chute. A rotary screw is rotatably provided in the telescopic chute. A telescopic slider is threadedly connected to the rotary screw. The telescopic slider is fixed to the moving block; the rear side of the telescopic chute is provided with a meshing cavity. The rear end of the rotating screw extends into the meshing cavity and a first bevel gear is fixedly connected to the left end of the first bevel gear. A gear rotating shaft is fixed at the center of the second bevel gear shaft, and the gear rotating shaft is dynamically connected with the transmission device.

10. The anti-theft window for facilitating emergency escape of middle and high-rise buildings according to claim 1, wherein the transmission device comprises a transmission cavity; a transmission block is slidably arranged in the transmission cavity, the gear shaft is rotatably connected to the transmission block, a hydraulic cylinder is fixed on the left end wall of the transmission cavity, and the touch module can control the operation of the hydraulic cylinder. A telescopic shaft is installed on the hydraulic cylinder, and the telescopic shaft is fixedly connected to the transmission block; the left side of the transmission cavity is provided with a belt cavity, and the upper and lower symmetrical pulleys are rotatably arranged in the belt cavity. The pulleys are dynamically connected by a transmission belt, and the left end of the winding shaft is fixedly connected with the lower pulley. The upper side of the pulley is provided with a spline groove, and the left end of the gear rotating shaft is splined to the spline groove.
